(19) United States
(12) Patent Application Publication
(10) Pub. No.: US 2026/0220225 A1
(43) Pub. Date: Jul. 30, 2026

(54) STABLE KERNEL FUNCTIONS FOR MACHINE LEARNING APPLICATIONS

(71) Applicant: QUALCOMM Incorporated, San Diego, CA (US)

(72) Inventors: Jamie Menjay Lin, San Diego, CA (US); Jian Shen, San Diego, CA (US)

(21) Appl. No.: 19/038,207

(22) Filed: Jan. 27, 2025

(51) Int. Cl. G06F 17/16

(52) U.S. Cl. CPC G06F 17/16

(57) ABSTRACT

This disclosure provides systems, methods, and devices that efficiently compute kernel functions for machine learning operations, such as on resource-constrained devices using low-bit quantized data representations. In one aspect, a method is provided that includes receiving first data and second data and determining normalized differences based on ratios of corresponding elements first and second data. Stabilized values are determined based on the normalized differences and a kernel output is determined, such as by aggregating the stabilized values and applying a transformation. A machine learning operation may then be determined according to the kernel output. The described techniques may utilize vector instructions or lookup tables to accelerate computation and may be applicable to transformer-based machine learning models and fixed-point arithmetic implementations. Other aspects are provided.

### TECHNICAL FIELD

Aspects of the present disclosure relate generally to machine learning techniques, and more particularly, to methods and systems suitable for determining stable kernel values for machine learning operations.

### INTRODUCTION

Machine learning techniques encompass a diverse array of computational methodologies designed to enable systems to learn from and make predictions or decisions based on data. These techniques typically involve the construction of models, algorithms, or neural network architectures that can infer patterns, trends, or structures within large datasets without explicit programming for each task. Machine learning techniques include supervised learning, where models are trained using labeled datasets; unsupervised learning, which involves the identification of patterns in unlabeled data; semi-supervised learning, which combines both labeled and unlabeled data; and reinforcement learning, where models learn optimal behaviors through trial and error interactions with an environment.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present techniques introduce numerically stable versions of Gaussian and Laplacian kernels designed for machine learning operations, such as on resource-constrained devices using low-bit quantization. By redefining the kernel functions to eliminate reliance on statistical parameters such as the mean and standard deviation, these techniques address numerical precision and stability issues inherent in fixed-point arithmetic with limited bit widths. Additionally, specialized vector processor instructions are proposed to accelerate the computation of these stable kernels, reducing computational complexity and improving efficiency on devices with constrained processing capabilities.

In one aspect, a method includes receiving first data and second data, determining normalized differences by calculating ratios of corresponding elements from the second data and the first data, determining stabilized values based on the normalized differences, determining a kernel output based on the stabilized values, and determining an output by performing a machine learning operation according to the kernel output.

In another aspect, a processor is configured to receive first data and second data, determine normalized differences by calculating ratios of corresponding elements from the second data and the first data, determine stabilized values based on the normalized differences, determine a kernel output based on the stabilized values, and determine an output by performing a machine learning operation according to the kernel output.

In a further aspect, a non-transitory computer-readable medium stores instructions which, when executed by a processor, cause the processor to perform operations including receiving first data and second data, determining normalized differences by calculating ratios of corresponding elements from the second data and the first data, determining stabilized values based on the normalized differences, determining a kernel output based on the stabilized values, and determining an output by performing a machine learning operation according to the kernel output.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example image processing configuration for a vehicle according to one or more aspects of the disclosure.

FIG. 2 is a block diagram illustrating details of an example wireless communication system according to one or more aspects.

FIG. 3A is a block diagram illustrating a system for determining stable kernel values for machine learning operations according to one or more aspects of the disclosure.

FIGS. 3B and 3C depict instruction-based optimizations for determining stable kernel values for machine learning operations according to aspects of the present disclosure.

FIG. 4 is a flow chart illustrating an example method for determining stable kernel values for machine learning operations according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In computer vision and machine learning, kernel functions like the Gaussian kernel and the Laplacian kernel are fundamental tools for measuring similarity or affinity between data points. Kernels may be used in tasks such as stereo depth estimation, optical flow estimation, feature matching, and attention mechanisms in neural networks. For instance, a standard Gaussian kernel a defined as:

$$G ( X , Y , σ ) = {e}^{- \frac{{\vert X - Y \vert}_{2}^{2}}{2 {σ}^{2}}} , X , Y ∈ {R}^{N}$$

where:

$${\vert X - Y \vert}_{2}^{2} = {\sum }_{i = 1}^{N} {( {x}_{i} - {y}_{i} )}^{2}$$

represents the squared Euclidean distance between vectors X and Y, where xᵢ and yⱼ are the components of X and Y respectively, and N is the dimensionality of the vectors. The parameter σ is the standard deviation, calculated as:

$$σ = \sqrt{\frac{1}{N} {\sum }_{i = 1}^{N} {( {x}_{i} - {y}_{i} - μ )}^{2}} ,$$

$$μ = \frac{1}{N} {\sum }_{i = 1}^{N} ( {x}_{i} - {y}_{i} )$$

Here, μ is the mean difference between the components of X and Y.

Similarly, the standard Laplacian kernel may be defined as:

$$L ( X , Y , b ) = {e}^{- \frac{{\vert X - Y \vert}_{1}}{b}} ,$$

$${\vert X - Y \vert}_{1} = {\sum }_{i = 1}^{N} \vert {x}_{i} - {y}_{i} \vert ,$$

$$σ = \sqrt{2} b$$

where |X−Y|₁ denotes the Manhattan distance between X and Y, and b is a scaling parameter related to the standard deviation σ.

These kernels inherently rely on calculations involving the mean μ and standard deviation σ of high-dimensional tensors. When deploying machine learning models, such as neural networks, on resource-constrained devices, such as edge devices, models are often quantized to low-bit representations such as INT8 or INT4 to reduce memory footprint and increase computational efficiency. This quantization leads to numerical precision issues because the exponential functions in standard kernels require high numerical precision and have a wide dynamic range, which low-bit representations cannot accurately capture. For example, in INT8 quantization, representing values resulting from the exponential function

$${e}^{- \frac{{\vert X - Y \vert}_{2}^{2}}{2 {σ}^{2}}}$$

is challenging due to limited dynamic range, resulting in significant quantization errors.

Moreover, to meet power and latency constraints, on-device neural networks often use tensors with reduced channel sizes, such as reducing from 256 channels to 16 or 8 channels. Computing the mean μ and standard deviation σ with a small number of samples (small N) leads to noisy and unstable estimates. These unstable or inaccurate estimates of σ adversely affect the computation of the kernels, resulting in decreased model accuracy and reliability.

Additionally, computing standard kernels can include expensive operations, including calculating the mean μ, calculating the standard deviation σ, and computing the exponential function. On resource-constrained devices, such computations are resource-intensive and impact latency and power consumption, making these formulations inefficient for real-time applications on hardware with limited computational capabilities.

In order to address these problems, the present techniques propose redefining the Gaussian and Laplacian kernels to reduce or eliminate reliance on statistical parameters and simplify computations compatible with low-bit quantization. In certain implementations, the stable Gaussian kernel is defined as:

$${G}_{stable} ( X , Y ) = {e}^{- {\sum }_{i = 1}^{N} {( 1 - \frac{{y}_{i}}{{x}_{i}} )}^{2}}$$

This redefinition normalizes each element by its corresponding xᵢ, avoiding the need to compute μ and σ. The term

$$\frac{{y}_{i}}{{x}_{i}}$$

may be a dimensionless ratio, reducing sensitivity to scale changes and improving numerical stability.

Similarly, in certain implementations, the stable Laplacian kernel is defined as:

$${L}_{stable} ( X , Y ) = {e}^{- {\sum }_{i = 1}^{N} \vert 1 - \frac{{y}_{i}}{{x}_{i}} \vert}$$

By handling numerical stability through these redefinitions, the issues related to unstable estimation of statistical parameters due to small tensor sizes are mitigated. The need to compute μ and σ is eliminated, reducing the number of arithmetic operations and simplifying computations. The operations involved, such as division, subtraction, squaring, or taking the absolute value, can be efficiently implemented with low-bit integers, and the reduced dynamic range avoids overflow or underflow issues. The exponential function's argument becomes small, allowing for accurate approximation or implementation using lookup tables suitable for fixed-point arithmetic.

To further enhance computational efficiency, specialized vector processor instructions may be used. In certain implementations, instructions such as VDivSqAcc (Vector Divide Square Accumulate) and VDivAbsAcc (Vector Divide Absolute Accumulate) are used to accelerate computations. These instructions perform the division, subtraction, and accumulation in a vectorized manner, optimizing performance on devices with vector processing capabilities. For example, when computing the stable Gaussian kernel, the VDivSqAcc instruction operates on vectors X and Y, performing element-wise division to compute

$$\frac{{y}_{i}}{{x}_{i}} ,$$

subtracting the result from one, squaring the difference, and accumulating the sum across all elements. This vectorized computation significantly reduces processing time and improves efficiency.

In addition or alternatively to introducing specialized vector processor instructions, the present techniques may employ lookup tables to further accelerate the computation of the stable kernels. In certain implementations, precomputed values of the exponential function are stored in a lookup table, allowing for rapid retrieval during kernel computation. As the ratios

$$\frac{{y}_{i}}{{x}_{i}}$$

in the stable kernels are typically close to one and the differences

$$( 1 - \frac{{y}_{i}}{{x}_{i}} )$$

are small, the range of possible values for the exponents is limited. This makes the size of the lookup table manageable, even when using low-bit representations like INT8 or INT4. For example, when computing the stable Gaussian kernel, the values of

$${( 1 - \frac{{y}_{i}}{{x}_{i}} )}^{2}$$

can be quantized into discrete levels, and their corresponding exponential values e^{-z} can be stored in the lookup table. During execution, the quantized z values are used as indices to retrieve the precomputed exponential results directly from the table, significantly reducing computational overhead. This approach eliminates the need for performing division and exponentiation operations on the fly, thereby enhancing computational efficiency and allowing the stable kernels to be computed swiftly on resource-constrained devices.

Particular implementations of the subject matter described in this disclosure may be implemented to realize one or more of the following potential advantages or benefits. The described techniques provide significant benefits by improving numerical stability and precision in fixed-point arithmetic for low-bit quantized neural networks deployed on resource-constrained devices. In certain implementations, redefining the Gaussian and Laplacian kernel functions to eliminate reliance on statistical parameters such as the mean and standard deviation enhances the reliability of model performance, even when using reduced tensor sizes. This redefinition addresses numerical precision issues that arise from low-bit quantization by reducing sensitivity to quantization errors and minimizing the impact of noisy statistical estimates.

Additionally, the techniques may reduce computational complexity by simplifying kernel computations. In certain implementations, expensive operations such as computing the mean, standard deviation, and exponential functions are replaced with more efficient element-wise computations and accumulations. This simplification may lead to faster processing times and lower power consumption, which is particularly beneficial for real-time applications on devices with limited computational resources.

Furthermore, the present techniques may optimize resource utilization and reduce latency by introducing specialized vector processor instructions and employing lookup tables. In certain implementations, vectorized instructions enable parallel processing of data elements, accelerating the computation of stable kernels. Lookup tables may store precomputed values for functions like the exponential, allowing for rapid retrieval during computations and eliminating the need for complex calculations on the fly. These optimizations may enable the real-time execution of advanced computer vision tasks, such as depth estimation and optical flow computation, on devices like smartphones, XR glasses, and autonomous vehicles. As a result, end users may experience enhanced applications with faster execution and improved accuracy, such as smoother augmented reality experiences and more responsive autonomous driving systems.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

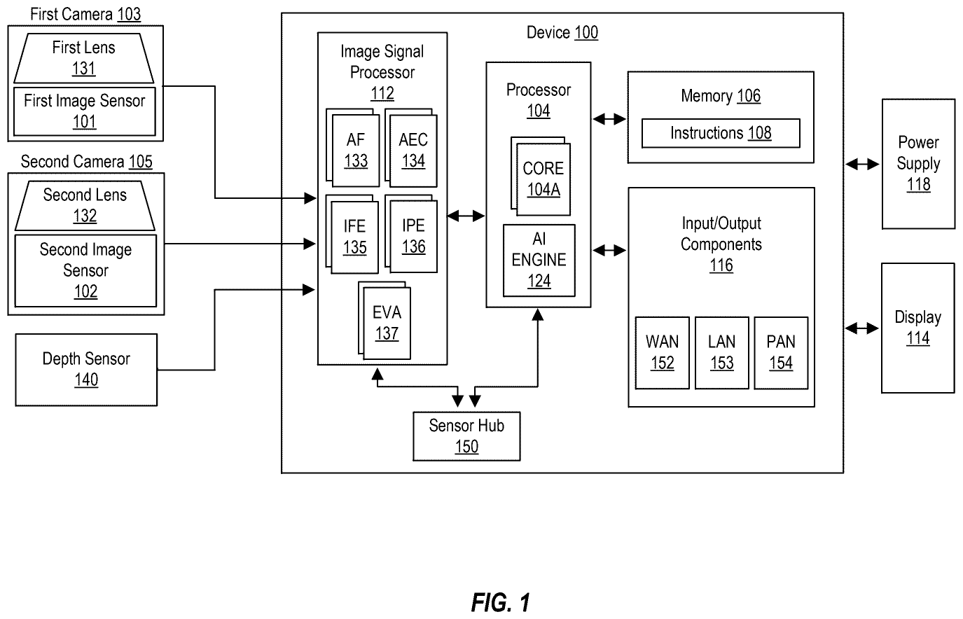

FIG. 1 shows a block diagram of an example processing system 100 according to one or more aspects of the disclosure. The processing system 100 may include, or otherwise be coupled to, a processor (e.g., CPU) 104 and an artificial intelligence (AI) engine 124 configured to execute neural network models employing Stable Gaussian and Laplacian Kernels as described herein. In some implementations, the processing system 100 also includes a memory 106 storing instructions 108 for implementing the methods disclosed. The processing system 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, such as other computing devices, mobile devices, vehicles, and/or a remote monitoring system. The network interfaces may include one or more of a wide area network (WAN) adaptor 152, a local area network (LAN) adaptor 153, and/or a personal area network (PAN) adaptor 154. An example WAN adaptor 152 is a 4G LTE or a 5G NR wireless network adaptor. An example LAN adaptor 153 is an IEEE 802.11 WiFi wireless network adaptor. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The processing system 100 may further include or be coupled to a power supply 118, such as a mains power supply, a battery, and the like. The processing system 100 may also include or be coupled to additional features or components that are not shown in FIG. 1. In one example, a wireless interface, which may include one or more transceivers and associated baseband processors, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The processing system 100 may include a sensor hub 150 for interfacing with and/or receiving data from sensors (such as non-camera sensors). Data from these sensors may be processed using neural network models employing the Stable Gaussian and Laplacian Kernels as described herein. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 150 may interface to a vehicle bus for sending configuration commands and/or receiving information from vehicle sensors 172, such as distance (e.g., ranging) sensors or vehicle-to-vehicle (V2V) sensors (e.g., sensors for receiving information from nearby vehicles). Other examples of sensors may include pressure sensors, temperature sensors, light sensors, and the like. In certain implementations, the sensors may be communicatively coupled to the sensor hub 150 through a direct connection (such as a bus connection). In additional or alternative implementations, the sensors may be indirectly coupled to the sensor hub (such as via a network connection).

The image signal processor (ISP) 112 may receive image data, such as used to form image frames. These image frames may be processed by the processor 104 using neural network models that employ the Stable Gaussian and Laplacian Kernels as described herein, for tasks such as depth estimation and feature matching. In one embodiment, a local bus connection couples the image signal processor 112 to image sensors 101 and 102 of a first camera 103 and second camera 105, respectively. In another embodiment, a wire interface may couple the image signal processor 112 to an external image sensor. In a further embodiment, a wireless interface may couple the image signal processor 112 to the image sensors 101 and 102.

The first camera 103 may include the first image sensor 101 and a corresponding first lens 131. The second camera 105 may include the second image sensor 102 and a corresponding second lens 132. Image data from the image sensors 101 and 102 may be processed by the processor 104 using neural network models employing the Stable Gaussian and Laplacian Kernels for applications such as stereo depth estimation. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140. In some embodiments, the lenses 131 and 132 may have a fixed focus.

Each of the cameras 103, 105 may include one, two, or more image sensors 101, 102. For example, the camera 103 may include a first image sensor 101 and a second image sensor (not depicted). When multiple image sensors are present, data from these sensors may be combined and processed using neural network models employing the Stable Kernels to enhance tasks like depth estimation and feature extraction. When multiple image sensors are present, the first image sensor 101 may have a larger field of view (FOV) than the second image sensor or the first image sensor 101 may have different sensitivity or different dynamic range than the second image sensor. In one example, the first image sensor 101 may be a wide-angle image sensor, and the second image sensor may be a telephoto image sensor. In another example, the first image sensor 101 is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view. Although the example discussed above focused on the first camera 103, the second camera 105 may be configured using one or more of the configurations discussed above (such as with a first image sensor 102 and a second image sensor (not depicted)).

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The captured data may be processed using the methods described herein involving Stable Gaussian and Laplacian Kernels to perform enhanced image processing tasks. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines (IPEs) 136, and/or one or more auto exposure compensation (AEC) 134 engines. The AF 133, AEC 134, IFE 135, and IPE 136 may each include application-specific circuitry, be embodied as software code executed by the ISP 112, and/or a combination of hardware within and software code executing on the ISP 112.

In some implementations, the memory 106 may include a non-transient or non-transitory computer readable medium storing computer-executable instructions 108 to perform all or a portion of one or more operations described in this disclosure. In particular, the instructions 108 may include instructions for implementing neural network models employing the Stable Gaussian and Laplacian Kernels, and for executing vector processor instructions to accelerate their computation as described d herein. In some implementations, the instructions 108 include a camera application (or other suitable application) to be executed during operation of the processing system 100 for generating images or videos. The instructions 108 may also include other applications or programs executed for the processing system 100, such as an operating system, mapping applications, or entertainment applications. Execution of the camera application, such as by the processor 104, may cause the processing system 100 to generate images using the image sensors 101 and 102 and the image signal processor 112. The memory 106 may also be accessed by the image signal processor 112 to store processed frames or may be accessed by the processor 104 to obtain the processed frames. In some embodiments, the processing system 100 includes a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including processing neural network models employing Stable Gaussian and Laplacian Kernels for applications such as stereo depth estimation, optical flow estimation, and feature matching. For example, execution of the instructions can instruct the image signal processor 112 to begin or end capturing an image frame or a sequence of image frames. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106. In executing the camera application, the processor 104 may be configured to instruct the image signal processor 112 to perform one or more operations with reference to the image sensors 101, 102, as discussed above.

In some embodiments, the processor 104 may include ICs or other hardware (e.g., an artificial intelligence (AI) engine 124) in addition to the ability to execute software to cause the processing system 100 to perform a number of functions or operations, such as the operations described herein. Particular implementations of the methods for computing Stable Gaussian and Laplacian Kernels may be performed by the AI engine 124, which may include specialized vector processor instructions as described herein to accelerate computation. In some other embodiments, the processing system 100 does not include the processor 104, such as when all of the described functionality is configured in the image signal processor 112. In particular embodiments, the processor 104 and/or another processor of the processing system 100 may include a machine learning processor. Machine learning processors may include one or more processing units tailored for operating/manipulating machine learning data/features structures (e.g., tensors), executing machine learning algorithms, or a combination thereof. A first example machine learning processor includes Neural Processors (NPs), hardware components specifically designed to perform calculations necessary for artificial neural networks, leveraging parallel processing capabilities to handle complex computational tasks efficiently. A second example machine learning processor includes Hardware-Based Machine Learning Accelerators (MLAs) that enhance the speed of machine learning applications by optimizing the underlying hardware for specific machine learning algorithms (such as for particular types of computing operations). A third example machine learning processor may include a machine learning (ML) core within a CPU, which may be embedded in a traditional CPU and may be specifically optimized to accelerate machine learning workloads or computations. A fourth example machine learning processor may include Neural Signal Processors (NSPs) and/or Neural Processing Units (NPUs), which are other types of processors that are designed for optimized performance with neural network-based workloads.

In some embodiments, the AI engine 124 may execute machine learning operations, including one or more machine learning models, to perform tasks such as image recognition, object detection, depth estimation, optical flow estimation, feature matching, and other computer applications. These tasks involve processing large amounts of data using mathematical models to extract patterns and make predictions or decisions based on input data. In some embodiments, the AI engine 124 employs kernel functions to measure similarity or affinity between data points in a feature space. Such kernel functions may facilitate operations like feature matching and dense correspondence by quantifying the similarity between feature vectors extracted from images or other sensor data.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the processing system 100 is referred to in the examples herein for including aspects of the present disclosure, some device components may not be shown in FIG. 1 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the processing system 100.

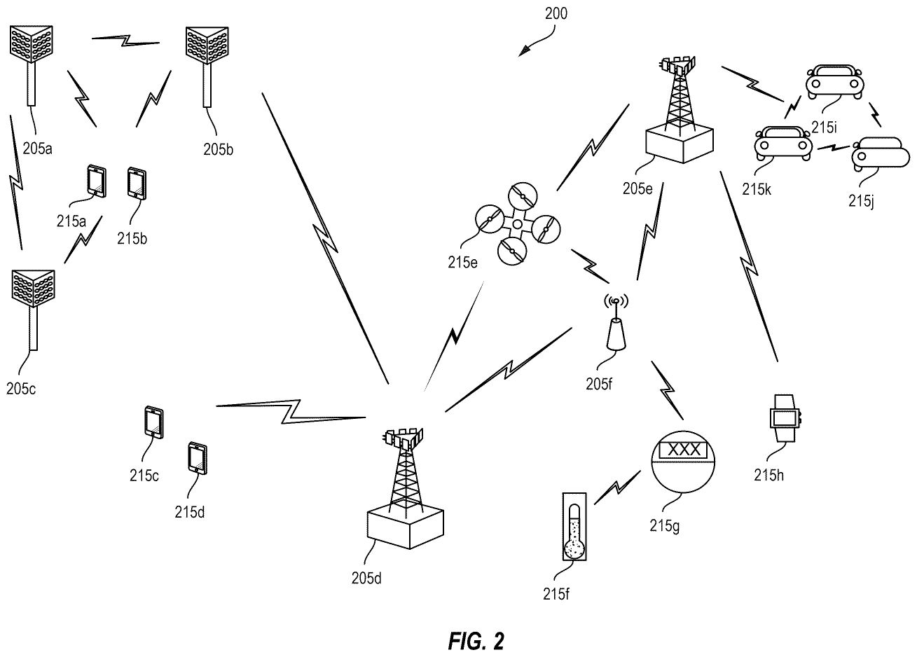

The processing system 100 may communicate as a user equipment (UE) within a wireless network 200, such as through WAN adaptor 152, as shown in FIG. 2. FIG. 2 is a block diagram illustrating details of an example wireless communication system according to one or more aspects. Wireless network 200 may, for example, include a 5G wireless network. As appreciated by those skilled in the art, components appearing in FIG. 2 are likely to have related counterparts in other network arrangements including, for example, cellular-style network arrangements and non-cellular-style-network arrangements (e.g., device-to-device or peer-to-peer or ad-hoc network arrangements, etc.).

Aspects of the systems described with reference to, and shown in, FIGS. 1 and 2 may include determining Stable Gaussian and Laplacian Kernels for use in neural network computations. In particular, the processing system 100 may employ specialized vector processor instructions to accelerate the computation of these stable kernels, reducing computational complexity and improving numerical stability in machine learning tasks.

Wireless network 200 includes base stations 205 and other network entities. A base station may be a station that communicates with the UEs and may also be referred to as an evolved node B (eNB), a next generation eNB (gNB), an access point, and the like. Each base station 205 may provide communication coverage for a particular geographic area. In 3GPP, the term “cell” may refer to this particular geographic coverage area of a base station or a base station subsystem serving the coverage area, depending on the context in which the term is used. In implementations of wireless network 200 herein, base stations 205 may be associated with a same operator or different operators (e.g., wireless network 200 may include a plurality of operator wireless networks). Additionally, in implementations of wireless network 200 herein, base station 205 may provide wireless communications using one or more of the same frequencies (e.g., one or more frequency bands in licensed spectrum, unlicensed spectrum, or a combination thereof) as a neighboring cell. In some examples, an individual base station 205 or UE 215 may be operated by more than one network operating entity. In some other examples, each base station 205 and UE 215 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 2, base stations 205d and 205e are regular macro base stations, while base stations 205a-205c are macro base stations enabled with one of three-dimension (3D), full dimension (FD), or massive MIMO. Base stations 205a-205c take advantage of their higher dimension MIMO capabilities to exploit 3D beamforming in both elevation and azimuth beamforming to increase coverage and capacity. Base station 205f is a small cell base station which may be a home node or portable access point. A base station may support one or multiple (e.g., two, three, four, and the like) cells.

Wireless network 200 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 215 are dispersed throughout the wireless network 200, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 215, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 215i-k are specifically shown as vehicles, a vehicle may employ the communication configuration described with reference to any of the UEs 215a-215k.

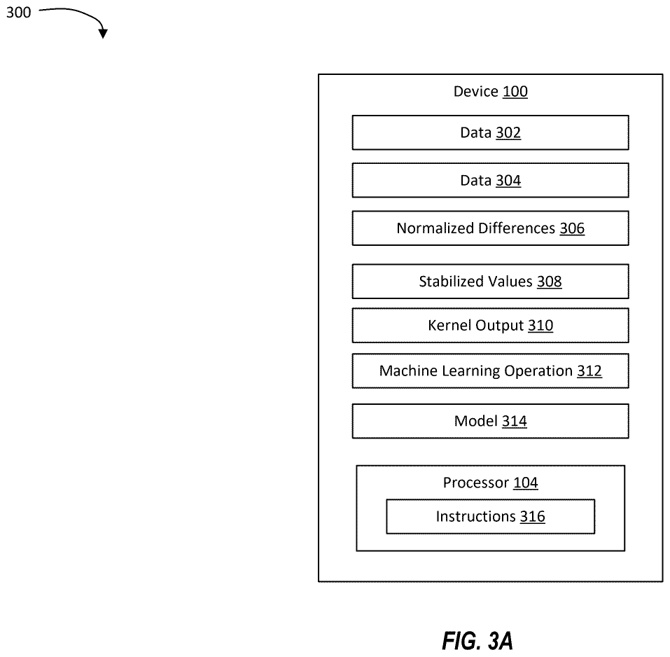

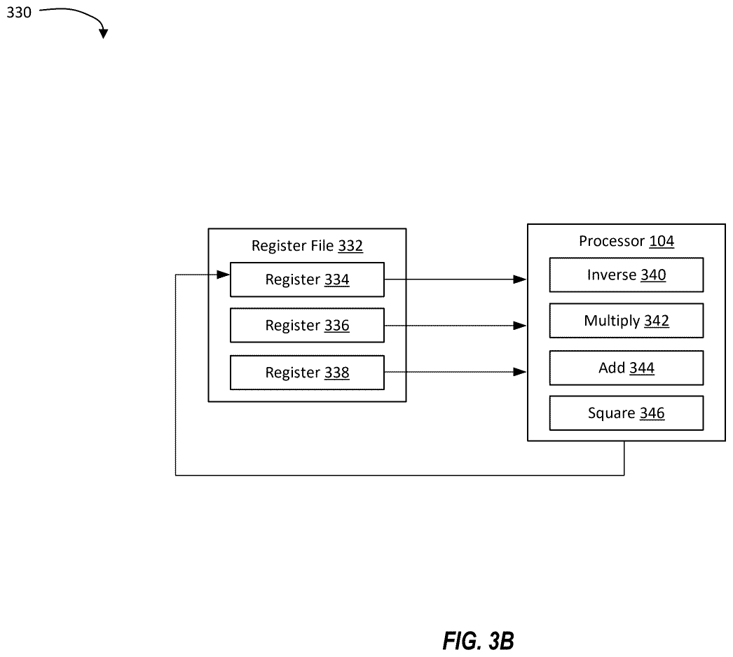

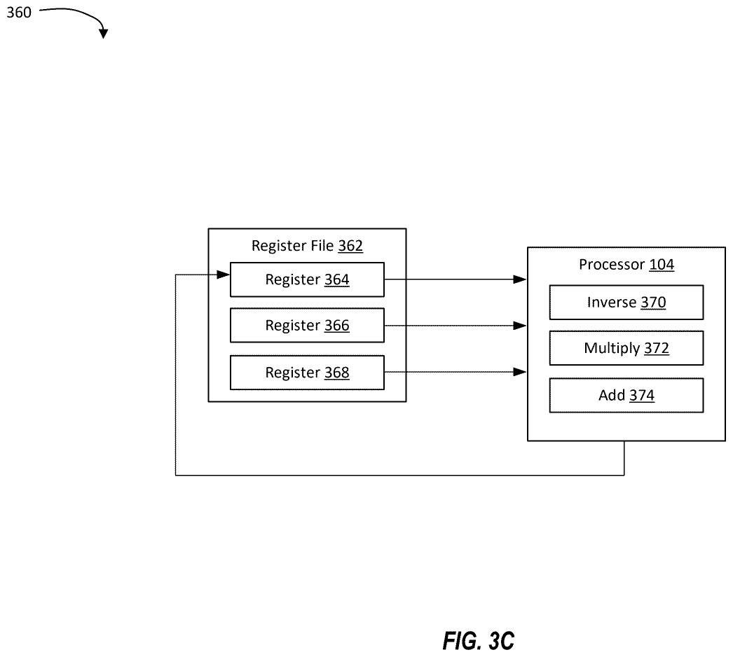

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 215a-215d of the implementation illustrated in FIG. 2 are examples of mobile smart phone-type devices accessing wireless network 200. A UE may also be a machine specifically configured for connected communication, including machine type communication (MTC), enhanced MTC (eMTC), narrowband IoT (NB-IOT) and the like. UEs 215e-215k illustrated in FIG. 3 are examples of various machines configured for communication that access wireless network 200.

A mobile apparatus, such as UEs 215, may be able to communicate with any type of the base stations, whether macro base stations, pico base stations, femto base stations, relays, and the like. In FIG. 2, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 200 may occur using wired or wireless communication links.

In operation at wireless network 200, base stations 205a-205c serve UEs 215a and 215b using 3D beamforming and coordinated spatial techniques, such as coordinated multipoint (CoMP) or multi-connectivity. Macro base station 205d performs backhaul communications with base stations 205a-205c, as well as small cell, base station 205f. Macro base station 205d also transmits multicast services which are subscribed to and received by UEs 215c and 215d. Such multicast services may include mobile television or stream video, or may include other services for providing community information, such as weather emergencies or alerts, such as Amber alerts or gray alerts.

Wireless network 200 of implementations supports mission critical communications with ultra-reliable and redundant links for mission critical devices, such UE 215e, which is a drone. Redundant communication links with UE 215e include from macro base stations 205d and 205e, as well as small cell base station 205f. Other machine type devices, such as UE 215f (thermometer), UE 215g (smart meter), and UE 215h (wearable device) may communicate through wireless network 200 either directly with base stations, such as small cell base station 205f, and macro base station 205e, or in multi-hop configurations by communicating with another user device which relays its information to the network, such as UE 215f communicating temperature measurement information to the smart meter, UE 215g, which is then reported to the network through small cell base station 205f. Wireless network 200 may also provide additional network efficiency through dynamic, low-latency TDD communications or low-latency FDD communications, such as in a vehicle-to-vehicle (V2V) mesh network between UEs 215i-215k communicating with macro base station 205e.

Aspects of the systems described with reference to, and shown in, FIGS. 1 and 2 may include determining attention weights for use in determining machine learning outputs. In particular, attention weights may be determined to reduce or remove multiplication steps.

FIG. 3A is a block diagram illustrating a system 300 for determining stable geometric kernels for machine learning operations according to one aspect of the present disclosure. The system 100 may be an exemplary implementation of the processing system 100. As noted above, machine learning processors (such as the machine learning processor 120) may be implemented as one or more of a neural processor, a hardware-based machine learning accelerator, a machine learning core within a CPU, an NSP, an NPU, an AI engine, and the like. The system 300 includes the device 100, which includes first data 302, second data 304, normalized differences 306, stabilized values 308, a kernel output 310, a machine learning operation 312, a model 314, and the processor 104, which includes instructions 316.

The computing device 100 may be configured to receive first data 302 and second data 304. The first data 302 and the second data 304 may refer to data inputs used in a machine learning operation 312, such as feature vectors extracted from data samples or outputs from intermediate layers of a neural network model 314.

In certain implementations, the first data 302 and the second data 304 may be represented in fixed-point data formats. Fixed-point data formats may refer to numerical values where a fixed number of digits are allocated for the integer part and fractional part of the number. This format allows for efficient computational operations using integer arithmetic units within the processor 104, reducing the need for floating-point units. For example, the first data 302 and second data 304 may be stored using 16-bit fixed-point numbers, where 8 bits are used for the integer part and 8 bits for the fractional part. In other implementations, the first data 302 and the second data 304 may be represented using low-bit quantized data formats. Low-bit quantization involves reducing the number of bits used to represent numerical values, such as using 8 bits (INT8) or 4 bits (INT4) instead of 32-bit floating-point representations. For instance, elements of the first data 302 and second data 304 may be quantized to INT8 format by mapping the floating-point values to an 8-bit integer range, such as using techniques like uniform quantization or dynamic range scaling.

In additional or alternative implementations, the first data 302 and the second data 304 may comprise one or more multidimensional arrays. These multidimensional arrays, often referred to as tensors in machine learning applications, are data structures that can store numerical values across multiple dimensions. For example, a tensor could be a 3-dimensional array with dimensions representing height, width, and channels of an image. In practical implementations, the first data 302 and second data 304 might be tensors of shape [batch_size, sequence_length, embedding_dimension], where batch_size is the number of samples processed simultaneously, sequence_length is the length of the input sequence (such as words in a sentence or frames in a video), and embedding_dimension is the size of the feature representation.

In certain implementations, the machine learning operation 312 may be performed by a transformer-based machine learning model 314. Transformer models are a class of neural networks that utilize self-attention mechanisms to process sequential input data, such as text or time series, allowing the model to weigh the influence of different parts of the input on each other. In this context, the first data 302 and the second data 304 may be outputs from transformer layers of the transformer-based machine learning model 314. Within the transformer model 314, the first data 302 and second data 304 may correspond to the query (Q) and key (K) matrices generated during the attention mechanism. The queries and keys are obtained by projecting the input embeddings or outputs from previous layers through learned linear transformations. The computing device 100 may use these matrices to compute attention scores that determine the relevance of each element in the sequence relative to others.

Determining the output by performing the machine learning operation 312 according to the kernel output 310 may involve using the kernel output 310 to compute attention weights in the transformer-based machine learning model 314. The kernel output 310 represents the similarity measures between the queries and keys, calculated using the stabilized values 308 obtained from the normalized differences 306. The attention weights are then computed by applying a softmax function to the kernel output 310, allowing the model to focus on the most relevant parts of the input sequence.

In another implementation, the machine learning operation 312 may include a feature matching operation in a machine learning model 314, where the first data 302 and second data 304 are feature vectors. Feature matching may include comparing feature vectors extracted from different data samples to determine their similarity or correspondence, such as for applications like image recognition, stereo vision, or pattern recognition. In such cases, the first data 302 and second data 304 may represent feature vectors extracted from different images, sensors, or data samples. The computing device 100 may compute the kernel output 310, which provides a similarity measure between these feature vectors using the stabilized kernels. This similarity measure influences the matching process by identifying pairs of feature vectors that are likely to correspond to the same object or pattern. For instance, in stereo depth estimation, feature vectors from the left and right camera images (such as images from image sensors 101 and 102) are compared.

The computing device 100 may receive the first data 302 and second data 304 from various data sources. These data sources could include sensor outputs, such as images captured by cameras (such as image sensors 101 and 102), signals from other devices, data retrieved from memory 106, and the like.

In certain implementations, the computing device 100 may be configured to determine normalized differences 306 by calculating ratios of corresponding elements from the second data 304 and the first data 302. In this process, for each element pair (yᵢ, xᵢ), the system computes the normalized difference rᵢ as:

$${r}_{i} = \frac{{y}_{i}}{{x}_{i}}$$

where yᵢ is an element from the second data 304, and xᵢ is the corresponding element from the first data 302. This calculation provides a dimensionless ratio that facilitates subsequent computations in the machine learning operation 312.

In certain implementations, the computing device 100 may be configured to handle cases where the first data element xᵢ is zero to prevent division by zero errors. For example, when a zero is encountered in the first data 302, the system adds a predetermined constant ε to the zero element before performing the division. This adjustment ensures numerical stability and avoids undefined behavior in the computation of the normalized differences 306. For example, if xᵢ=0, the adjusted element becomes xᵢ=ε, where ε is a very small positive value, such as a minimum non-zero value in the number encoding, like 1×10⁻⁸.

In other implementations, the computing device 100 may determine the normalized differences 306 by calculating ratios of corresponding elements from the second data 304 and a normalization value associated with the first data 302. Instead of dividing by each individual element xᵢ, the system may use a single normalization value N derived from the first data 302. For instance, the normalization value N may be the maximum value among all elements of the first data 302. Such implementations may mitigate the effects of outliers and stabilize the range of the normalized differences. Additionally or alternatively, the normalization value N may be the mean (average) value of the elements of the first data 302.

In certain implementations, to reduce computational complexity, the computing device 100 calculates the normalized differences 306 using approximate reciprocal values of the first data elements xᵢ. Instead of performing direct division, which can be computationally intensive, the system may employ methods such as lookup tables or iterative algorithms to estimate the reciprocals

$$\frac{1}{{x}_{i}} .$$

For example, the system may utilize a precomputed lookup table that maps possible values of xᵢ to their approximate reciprocals. When an xᵢ is encountered, the system retrieves

$$\frac{1}{{x}_{i}} .$$

from the table and computes the normalized difference as:

$${r}_{i} = {y}_{i} \times ( \frac{1}{{x}_{i}} )$$

Such implementations may avoid division operations, replacing them with multiplication, which may less resource-intensive. While these methods introduce approximation errors, the trade-off between computational efficiency and precision may be acceptable, especially in applications where low-bit quantization already reduces numerical accuracy.

For instance, suppose xᵢ values are quantized to 8 bits, limiting their possible values to 256 distinct integers. The system can construct a lookup table of size 256, mapping each possible xᵢ to its reciprocal. During runtime, this table allows rapid retrieval of reciprocal values without performing division.

Handling special cases is crucial for robust computation. Aside from addressing division by zero, the computing device 100 may also be configured to manages instances where the first data elements xᵢ are near zero, which can result in excessively large normalized differences. In certain implementations, the computing device 100 may be configured to use threshold values below which xᵢ is treated as zero and apply the predetermined small constant ε as previously described.

As an example, suppose the first data 302 and second data 304 each contain elements xᵢ and yᵢ with values quantized to 8 bits (0 to 255). Suppose xᵢ=0 for a particular element. To compute the normalized difference, the computing device 100 may add ε=1 to xᵢ, resulting in xᵢ=1. The normalized difference may then be calculated as

$${r}_{i} = \frac{{y}_{i}}{1} = {y}_{i} .$$

This adjustment prevents division by zero and allows the computation to proceed without significant disruption.

In another example, if xᵢ is a small value like 2, and yᵢ=200, the normalized difference becomes

$${r}_{i} = \frac{200}{2} = 100 ,$$

which is a large value. In certain implementations, the system may impose a cap on rᵢ to prevent extreme values from adversely affecting subsequent computations.

The computing device 100 may be configured to determine stabilized values 308 based on the normalized differences 306. In this process, for each normalized difference rt, the device 100 may determine a stabilized value 308 sᵢ utilized in subsequent computations within the machine learning operation 312.

In certain implementations, the computing device 100 determines the stabilized value 308 sᵢ by squaring the difference between one and the normalized difference rᵢ, corresponding to the Stable Gaussian Kernel. In such instances, the stabilized value 308 may be determined as:

$${s}_{i} = {( 1 - \frac{{y}_{i}}{{x}_{i}} )}^{2}$$

where yᵢ is an element from the second data 304, and xᵢ is the corresponding element from the first data 302. By squaring the difference, the system captures the magnitude of deviation between yᵢ and xᵢ, ensuring that the stabilized value 308 is non-negative and that larger differences have a more significant impact.

For example, consider a case where xᵢ=8 and yᵢ=6. The normalized difference is calculated as

$${r}_{i} = \frac{6}{8} = 0.75 .$$

The stabilized value 308 is then computed as:

$${s}_{i} = {( 1 - 0.75 )}^{2} = {( 0.25 )}^{2} = 0.0625$$

To efficiently compute the stabilized values 308, the computing device 100 may execute a vector divide square accumulate instruction on the processor 104, such as within an AI engine 124 of the processor 104. For example, the vector divide square accumulate instruction may be an example of an instruction 316 stored in the processor 104. This specialized instruction allows for parallel processing of multiple data elements, significantly accelerating computations. The instruction performs several operations for corresponding elements of the first data 302 and the second data 304. In particular, the instruction may be configured to determine the ratios

$${r}_{i} = \frac{{y}_{i}}{{x}_{i}} ,$$

calculates the differences dᵢ=1−rᵢ, computes the squared differences

$${s}_{i} = {d}_{i}^{2} ,$$

and accumulates the squared differences into an accumulator register.

In implementing this, the computing device 400 may be configured to load the first data 302 and the second data 304 into vector registers within the processor 104 and initializes the accumulator register to zero. The vector divide square accumulate instruction is then executed over the vector registers, allowing simultaneous computation across multiple data elements. The instruction processes the data by performing division to calculate the ratios, subtraction to compute the differences between one and the ratios, squaring to determine the squared differences, and accumulation to update the accumulator with the sum of the squared differences.

FIG. 3B depicts an instruction-based system of for determining stable kernel values for machine learning operations according to one aspect of the present disclosure. The system 330 include featuring a register file 332 and the processor 104. The register file 332 includes multiple registers, such as register 334, register 336, and register 338, which store data during processing. These registers hold operands and intermediary results for operations carried out by the processor. In this system, the processor 104 includes several units, including an inverse unit 340, a multiply unit 342, an add unit 344, and a square unit 346.

The inverse unit 340 may be configured to compute reciprocal values, aiding in division operations where direct calculation may be computationally expensive on low-bit hardware. The multiply unit 342 may be configured to perform multiplication tasks, such as scaling or adjusting data magnitudes. The add unit 344 may be configured to perform addition. The square unit 346 may be configured to calculate squares of values, useful for determining stabilized values based on squared deviations.

The processor 104 may be configured with one or more instructions, such as a Vector Divide-Square Accumulate instruction, which are formed from combinations of (such as sequences of combined uses of the units 340, 342, 344, 346 and the registers 334, 336, 338). The interaction between the register file 332 and the processor 104 facilitates efficient execution of machine learning operations in the device 100. For example, data loaded into the registers 336, 338 may processed using these instructions, and results may then be written back to the register file (such as the register 334).

One such instruction is the VDivSqAcc instruction, which may be used to compute the stable Gaussian kernel:

```
integer elements = VectorLength DIV element_size;
for e = 0 to elements-1 {
      integer X = Int(Elem[Rm, e, esize], unsigned);
      integer Y = Int(Elem[Rn, e, esize], unsigned);
      if X == 0 then quotient = 0;
      else quotient = RoundTowardsZero(1 - Y/X)^{∧}2;
      Elem[result, e, esize] = quotient;
}
Rd = Rd + result;
```

In this code sample, elements from the second data 304 and first data 302 are processed using vector registers corresponding to the Rm and Rn registers (such as the registers 336, 338). For each element, the ratio is computed, and if X is zero, a default value prevents division errors. Otherwise, the value (1−Y/X)² is computed, representing a stabilized value for each element pair. The resulting quotient is accumulated in the Rd register (such as the 334) over the vector length.

As one particular example, suppose the first data 302 and second data 304 are defined as xᵢ=[2,4,6,8] and yᵢ=[1,3,5,7]. The instruction computes the ratios rᵢ=[0.5,0.75,0.8333,0.875] by dividing each yᵢ by the corresponding xᵢ. The instruction then calculates the differences dᵢ=[0.5,0.25,0.1667,0.125] by subtracting each ratio from one. Next, it computes the squared differences sᵢ=[0.25,0.0625,0.0278,0.0156] by squaring each difference. Finally, it accumulates the squared differences to obtain the sum R_{acc}=0.25+0.0625+0.0278+0.0156=0.356, which serves as the aggregated similarity metric for further processing.

In additional or alternative implementations, the computing device 100 may be configured to determine the stabilized value 308 sᵢ by taking the absolute value of the difference between one and the normalized difference rᵢ, corresponding to the Stable Laplacian Kernel. This method emphasizes linear differences, providing a different sensitivity profile compared to the squared method. In certain such instances, the stabilized values 308 may be determined as:

$${s}_{i} = \vert 1 - \frac{{y}_{i}}{{x}_{i}} \vert$$

By taking the absolute value, the system accounts for both positive and negative differences while maintaining non-negative stabilized values. For example, with xᵢ=5 and yᵢ=4, the normalized difference is

$${r}_{i} = \frac{4}{5} = 0.8 ,$$

and the stabilized value 308 is computed as sᵢ=|1−0.8|=0.2.

In certain implementations, to compute stabilized values 308 using the Stable Laplacian Kernel, the computing device 100 may execute a vector divide absolute accumulate instruction. For example, the vector divide accumulate instruction may be an example of an instruction 316 stored in the processor 104. This instruction operates by calculating the ratios

$${r}_{i} = \frac{{y}_{i}}{{x}_{i}} ,$$

computing the differences dᵢ=1−rᵢ, determining the absolute values sᵢ=|dᵢ|, and accumulating the absolute differences into an accumulator register. The data is loaded into vector registers within the processor 104, and the instruction processes all elements efficiently through parallel computation.

FIG. 3C depicts an instruction-based system 360 for determining stable kernel values for machine learning operations. The system 360 includes a register file 362 and the processor 104. The register file 362 includes multiple registers, such as register 364, register 366, and register 368, which store data during processing. These registers hold operands and intermediary results for operations carried out by the processor. The processor 104 includes several units, including an inverse unit 370, a multiply unit 372, and an add unit 374.

The inverse unit 370 may compute reciprocal values, aiding in operations where direct division may be computationally intensive on low-bit hardware. The multiply unit 372 performs multiplication tasks, such as scaling or adjusting data magnitudes. The add unit 374 carries out addition operations.

The processor 104 may include instructions such as a Vector Divide-Absolute Accumulate instruction, formed by combining these units and registers. The interaction between the register file 362 and the processor 104 ensures efficient execution of machine learning operations. For example, data loaded into registers 366, 368 may be processed using these instructions, and results may be written back to register 364.

One such instruction is the VDivAbsAcc instruction, which may be used to compute the stable Laplacian kernel:

```
integer elements = VectorLength DIV element_size;
for e = 0 to elements-1 {
      integer X = Int(Elem[Rm, e, esize], unsigned);
      integer Y = Int(Elem[Rn, e, esize], unsigned);
      if X == 0 then quotient = 0;
      else quotient = |1 - Y/X|;
      Elem[result, e, esize] = quotient;
}
Rd = Rd + result;
```

In this code sample, elements from the second data 304 and first data 302 are processed using vector registers corresponding to Rm and Rn, such as registers 366, 368. For each element, the ratio is computed, and if X is zero, a default value prevents division errors. Otherwise, the absolute value |1−Y/X| is computed, representing a stabilized value for each element pair. The resulting quotient is accumulated in the Rd register, such as register 364, over the vector length.

As one particular example, if the first data 302 and second data 304 are xᵢ=[3,6,9,12] and yᵢ=[2,5,8,11], the instruction may be configured to compute the ratios rᵢ=[0.6667,0.8333,0.8889,0.9167] by dividing each yᵢ by the corresponding xᵢ. The instruction then calculates the differences dᵢ=[0.3333,0.1667,0.1111,0.0833] by subtracting each ratio from one, and determines the absolute differences sᵢ=[0.3333,0.1667,0.1111,0.0833] by taking the absolute value of each difference. The system then accumulates these values to obtain the aggregated similarity metric R_{acc}=0.3333+0.1667+0.1111+0.0833=0.6944.

In certain implementations, the computing device 100 determines the stabilized values 308 by accessing a lookup table using the normalized differences 306. The lookup table stores precomputed stabilized values 308 corresponding to possible normalized differences, which accelerates computation by eliminating real-time calculations. The lookup table is structured as an indexed array or dictionary where indices correspond to quantized normalized difference values. If the normalized differences rᵢ are quantized to a certain precision, such as 8 bits, the table size becomes manageable, and precomputing stabilized values 308 for each possible rᵢ ensures quick retrieval during processing.

For example, if normalized differences range from 0 to 1 in increments of 0.01, the lookup table contains 101 entries. When processing a normalized difference rᵢ=0.75, the system rounds or maps rᵢ to the nearest index and retrieves the corresponding stabilized value 308 sᵢ. Such techniques may reduce computational overhead and is particularly beneficial in resource-constrained devices, ensuring consistency in computed values as rounding errors are confined to the quantization process.

The computing device 100 may be configured to determine a kernel output 310 based on the stabilized values 308. In this process, the system combines the stabilized values 308 to form an aggregated similarity metric, which is then transformed to compute the kernel output 310 used in the machine learning operation 312.

In certain implementations, the computing device 100 determines the aggregated similarity metric by summing the stabilized values 308. The aggregated similarity metric S is calculated as:

$$S = {\sum }_{i} {s}_{i}$$

where sᵢ represents each stabilized value 308 calculated from the normalized differences 306. Summing the stabilized values 308 provides a scalar metric that quantifies the overall similarity between the first data 302 and the second data 304.

For example, if the stabilized values 308 are sᵢ=[0.25,0.0625,0.0278,0.0156] as previously computed, the aggregated similarity metric S is:

$$S = 0.25 + 0.0625 + 0.0278 + 0.0156 = 0.3559$$

In certain implementations, the computing device 100 determines the kernel output 310 by applying a transformation to the aggregated similarity metric S. In certain implementations, the transformation may be determined as the exponential of the negative aggregated similarity metric, expressed as:

$$K = {e}^{- S}$$

where K is the kernel output 310, and e is the base of the natural logarithm. This transformation maps the aggregated similarity metric to a value between 0 and 1, providing a normalized measure of similarity suitable for machine learning operations 312.

Continuing the previous example, the kernel output 310 is calculated as:

$$k = {e}^{- 0.3559} \approx 0.7006$$

This kernel output 310 serves as a similarity measure between the first data 302 and the second data 304.

In certain implementations, to improve computational efficiency, the computing device 100 computes the exponential function by accessing a lookup table using the aggregated similarity metric S. The lookup table stores precomputed exponential values corresponding to possible aggregated similarity metrics, allowing the system to retrieve the kernel output 310 without performing the exponential calculation in real time.

The lookup table may be structured as an indexed array, where each index corresponds to a quantized value of S. For example, if S ranges from 0 to 10 in increments of 0.01, the lookup table contains 1001 entries. When S=0.3559, the system rounds S to the nearest index, such as 35.59 mapped to index 36, and retrieves the corresponding kernel output 310 from the table. This method reduces computational overhead and accelerates the processing, which is particularly beneficial in resource-constrained devices like the device 100.

In certain implementations, the computing device 100 may apply additional or alternative transformation functions to compute the kernel output 310. These functions may include polynomial functions, sigmoid functions, or other mathematical transformations that map the aggregated similarity metric S to a desired range or emphasize specific aspects of the data.

For example, a polynomial transformation may be:

$$K = \frac{1}{1 + S}$$

As another example, a sigmoid transformation may be:

$$K = \frac{1}{1 + {e}^{- S}}$$

The computing device 100 may be configured to determine an output by performing a machine learning operation 312 according to the kernel output 310. In certain implementations, the kernel output 310 may be used during the operation 312 as a similarity measure between the first data 302 and the second data 304, influencing how the machine learning model 314 processes the data.

In certain implementations, when the machine learning operation involves a transformer-based model 314, the system uses the kernel output 310 to compute attention weights, such as by replacing a typical dot-product similarity measure with the kernel output 310. For example, after computing the kernel outputs Kᵢⱼ for all pairs of queries and keys, the computing device 100 may determine the attention weights by normalizing these kernel outputs. The attention weights determine how much influence each element kⱼ has on the output associated with qᵢ.

In certain implementations, where the machine learning operation 312 comprises a feature matching operation within the model 314, the device 100 utilizes the kernel output 310 to compare feature vectors. The feature matching process may include evaluating the similarity between feature vectors extracted from different data samples to identify correspondences. For example, the kernel output 310 may quantify the degree of similarity between the feature vectors from the first data 302 and the second data 304.

Higher kernel output values indicate greater similarity, increasing the likelihood of an identified feature match. As a particular example, in image recognition tasks, the device 100 might extract feature vectors representing specific patterns or objects within images. In implementations where the described techniques are used for image processing, the techniques may be performed by the image signal process 112.

In additional or alternative implementations, the above-described techniques implemented by the computing device 100 can be applied to clustering, anomaly detection, or similar tasks that require a measure of similarity between data points.

In certain implementations, the described techniques may be performed on a resource-constrained computing device. In various aspects, resource-constrained devices may include smartphones, embedded systems, and Internet of Things (IOT) devices, which often have limited processing power, memory capacity, and energy resources. For example, a smartphone may have constraints on battery life and computational capabilities compared to a desktop computer or server.

Experimental results validate the effectiveness of the stable Gaussian kernels in improving model accuracy and numerical stability, particularly in stereo depth estimation tasks. Incorporating the stable Gaussian kernels into various model variants consistently led to higher accuracy, as demonstrated by lower End-Point Error (EPE) values. For instance, models utilizing the stable Gaussian kernel achieved notable improvements, with reductions in EPE ranging from 7.7% to 9.0% compared to models using the standard Gaussian kernel for multiplicative attention. Similarly, for additive attention models, the reduction in EPE was between 7.0% and 7.5%. These results highlight the enhanced precision provided by the described techniques in machine learning operations.

Moreover, the described techniques offer substantial benefits in terms of numerical precision and computational efficiency. By eliminating the need to evaluate the mean and standard deviation, the stable kernels address precision issues that are often exacerbated by reduced channel sizes in lightweight, on-device neural networks. The normalization process is simplified to rely solely on the first data X, thereby avoiding complex evaluations and stabilizing calculations within a fixed-point arithmetic framework. This approach minimizes dynamic range issues typically encountered when using standard kernels on resource-constrained devices.

Furthermore, the redefined kernel computations exhibit reduced computational complexity. By utilizing specialized vector processor instructions, such as the VDivSqAcc and VDivAbsAcc, and incorporating lookup tables for precomputed values, these techniques achieve faster processing times with reduced latency. This enhancement allows entire tensors to be processed more efficiently, fitting into multiple Single Instruction, Multiple Data (SIMD) vector instructions, which results in shorter latency and smaller code sizes. The stable kernel methods thus provide an effective solution for deploying machine learning operations on devices with limited computational resources, ensuring high performance and accuracy without sacrificing efficiency.

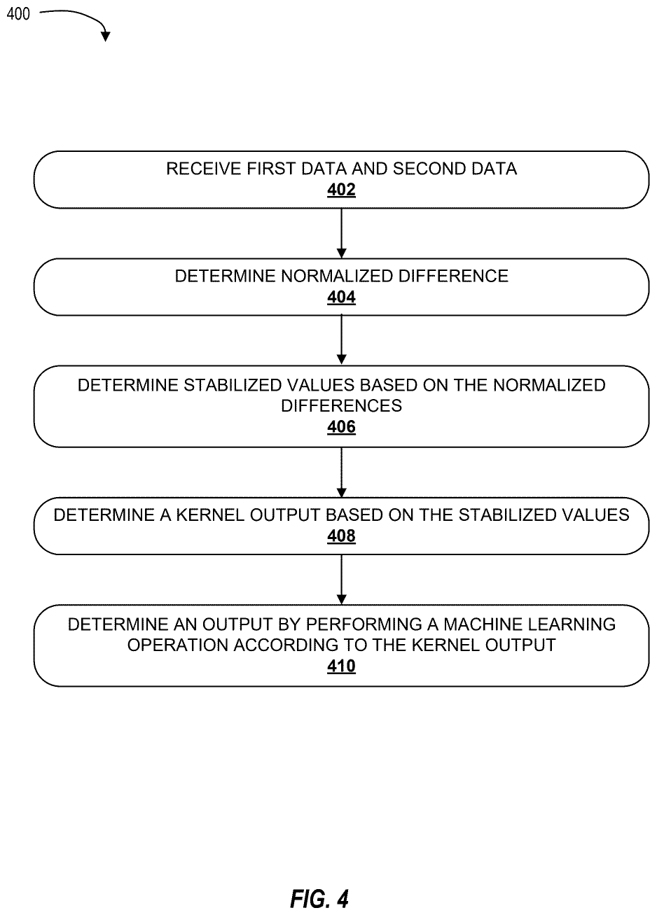

FIG. 4 is a flow chart illustrating an example method 400 for determining stable geometric kernels for machine learning operations according to one or more aspects of the present disclosure. The method may be performed by one or more of the above systems, such as the systems 100, 200, 300. The method 400 may be implemented on a computer system, such as the system 300. For example, the method 400 may be implemented by the device 100 and/or the processor 104. The method 400 may also be implemented by a set of instructions stored on a computer-readable medium that, when executed by a processor, cause the computing device to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

At block 402, the method 400 includes receiving first data and second data. For example, the computing device 100 may receive first data 302 and second data 304. In certain implementations, the first data and the second data include fixed-point data representations. For instance, the first data 302 and the second data 304 may be represented using fixed-point arithmetic to facilitate efficient computation on the processor 104. In other implementations, the first data and the second data include low-bit quantized data representations. For example, the first data 302 and the second data 304 may be quantized to low-bit formats such as INT8 or INT4 to reduce memory usage and computational complexity. In certain cases, the first data and the second data include one or more multidimensional arrays. For instance, the first data 302 and the second data 304 may be tensors representing multidimensional data structures used in machine learning operations.

At block 404, the method 400 includes determining normalized differences by calculating ratios of corresponding elements from the second data and the first data. For example, the computing device 100 may determine normalized differences 306 by calculating ratios of corresponding elements from the second data 304 and the first data 302. In certain implementations, for each corresponding element from the second data 304 and the first data 302, when the first data element is zero, the method 400 may include adding a predetermined value to the first data element to prevent division by zero. In some implementations, determining the normalized differences includes representing the normalized differences using fixed-point arithmetic. In certain implementations, determining the normalized differences includes calculating ratios of corresponding elements from the second data 304 and a normalization value associated with the first data 302, where the normalization value comprises a maximum value of the elements of the first data 302. In other implementations, the normalization value comprises a mean value of the elements of the first data 302. In some cases, the normalized differences are calculated using approximate reciprocal values of the first data elements to reduce computational complexity.

At block 406, the method 400 includes determining stabilized values based on the normalized differences. For example, the computing device 100 may determine stabilized values 308 based on the normalized differences 306. In certain implementations, for each normalized difference, the method 400 includes determining the stabilized value 308 by squaring the difference between one and the normalized difference. In some implementations, determining the stabilized values 308 includes executing a vector divide square accumulate instruction that, for corresponding elements of the first data 302 and the second data 304, determines the ratios of the second data elements to the first data elements, determines the differences between one and the ratios, determines squared differences by squaring the differences, and accumulates the squared differences. In certain implementations, the method 400 further includes loading the first data 302 and the second data 304 into vector registers, initializing an accumulator register to zero, executing the vector divide square accumulate instruction over the vector registers to compute and accumulate the squared differences into the accumulator register, determining an aggregated similarity metric by performing a reduction operation on the accumulator register, and determining the kernel output based on the aggregated similarity metric. In other implementations, for each normalized difference, the method includes determining the stabilized value 308 by taking the absolute value of the difference between one and the normalized difference. In certain implementations, determining the stabilized values 308 includes executing a vector divide absolute accumulate instruction that, for corresponding elements of the first data 302 and the second data 304, calculates the ratios of the second data elements to the first data elements, determines the differences between one and the ratios, determines the absolute values of the differences, and accumulates the absolute differences. In some cases, determining the stabilized values 308 includes accessing a lookup table using the normalized differences 306 to obtain the stabilized values 308, where the lookup table stores precomputed stabilized values 308 corresponding to possible normalized differences to accelerate computation.

At block 408, the method 400 includes determining a kernel output based on the stabilized values. For example, the computing device 100 may determine a kernel output 310 based on the stabilized values 308. In certain implementations, determining the kernel output includes determining an aggregated similarity metric by combining the stabilized values 308 and determining the kernel output by applying a transformation to the aggregated similarity metric. In some implementations, determining the aggregated similarity metric by combining the stabilized values 308 includes summing the stabilized values 308 to obtain the aggregated similarity metric. In certain implementations, the transformation comprises computing an exponential of the negative aggregated similarity metric to obtain the kernel output 310. In some cases, computing the exponential of the negative aggregated similarity metric includes accessing a lookup table using the aggregated similarity metric to obtain the kernel output 310, where the lookup table stores precomputed exponential values corresponding to possible aggregated similarity metrics to accelerate computation. In other implementations, determining the kernel output includes applying a transformation function selected from the group consisting of an exponential function, a polynomial function, and a sigmoid function.

At block 410, the method 400 includes determining an output by performing a machine learning operation according to the kernel output. For example, the computing device 100 may determine an output by performing a machine learning operation 312 according to the kernel output 310. In certain implementations, the machine learning operation is performed by a transformer-based machine learning model 314, and the first data 302 and the second data 304 are outputs from transformer layers of the transformer-based machine learning model 314. In some implementations, determining the output by performing the machine learning operation according to the kernel output includes using the kernel output to compute attention weights in the transformer-based machine learning model 314. In other implementations, the machine learning operation comprises a feature matching operation in a machine learning model 314, and the first data 302 and second data 304 are feature vectors. In certain cases, the kernel output 310 provides a similarity measure between the first data 302 and the second data 304 used in the machine learning operation 312.

It is noted that one or more blocks (or operations) described with reference to FIG. 4 may be combined with one or more blocks (or operations) described with reference to another of the figures. For example, one or more blocks (or operations) of FIG. 4 may be combined with one or more blocks (or operations) of FIG. 1-3.

In one or more aspects, techniques for supporting vehicular operations may include additional aspects, such as any single aspect or any combination of aspects described below or in connection with one or more other processes or devices described elsewhere herein.

In a first aspect, a method includes receiving first data and second data, determining normalized differences by calculating ratios of corresponding elements from the second data and the first data, determining stabilized values based on the normalized differences, determining a kernel output based on the stabilized values, and determining an output by performing a machine learning operation according to the kernel output.

In a second aspect according to the first aspect, determining the stabilized values comprises, for each normalized difference, determining the stabilized value by squaring the difference between one and the normalized difference.

In a third aspect according to the second aspect, determining the stabilized values comprises executing a vector divide square accumulate instruction that, for corresponding elements of the first data and the second data, determines the ratios of the second data elements to the first data elements, determines the differences between one and the ratios, determines squared differences by squaring the differences, and accumulates the squared differences.

In a fourth aspect according to any one of the first through third aspects, determining the stabilized values comprises, for each normalized difference, determining the stabilized value by taking the absolute value of the difference between one and the normalized difference.

In a fifth aspect according to the fourth aspect, determining the stabilized values comprises executing a vector divide absolute accumulate instruction that, for corresponding elements of the first data and the second data, calculates the ratios of the second data elements to the first data elements, determines the differences between one and the ratios, determines the absolute values of the differences, and accumulates the absolute differences.

In a sixth aspect according to any one of the first through fifth aspects, determining the stabilized values comprises determining the stabilized values from a lookup table based on the normalized differences.

In a seventh aspect according to any one of the first through sixth aspects, determining the kernel output comprises determining an aggregated similarity metric by combining the stabilized values and determining the kernel output by applying a transformation to the aggregated similarity metric.

In an eighth aspect according to the seventh aspect, determining the aggregated similarity metric by combining the stabilized values comprises determining the aggregated similarity metric by summing the stabilized values.

In a ninth aspect according to any one of the seventh or eighth aspects, the transformation comprises determining the kernel output by computing an exponential based on the aggregated similarity metric.

In a tenth aspect according to the ninth aspect, computing the exponential based on the aggregated similarity metric comprises determining the kernel output from a lookup table based on the aggregated similarity metric.

In an eleventh aspect according to any one of the first through tenth aspects, determining the normalized differences comprises, for each corresponding element from the second data and the first data, determining that the first data element is zero and adding a predetermined value to the first data element.

In a twelfth aspect, a processor is configured to receive first data and second data, determine normalized differences by calculating ratios of corresponding elements from the second data and the first data, determine stabilized values based on the normalized differences, determine a kernel output based on the stabilized values, and determine an output by performing a machine learning operation according to the kernel output.

In a thirteenth aspect according to the twelfth aspect, the processor is configured to determine the stabilized values by, for each normalized difference, determining the stabilized value by squaring the difference between one and the normalized difference.

In a fourteenth aspect according to the thirteenth aspect, the processor is configured to execute a vector divide square accumulate instruction that, for corresponding elements of the first data and the second data, determines the ratios of the second data elements to the first data elements, determines the differences between one and the ratios, determines squared differences by squaring the differences, and accumulates the squared differences.

In a fifteenth aspect according to any one of the twelfth through fourteenth aspects, the processor is configured to determine the stabilized values by, for each normalized difference, determining the stabilized value by taking the absolute value of the difference between one and the normalized difference.

In a sixteenth aspect according to the fifteenth aspect, the processor is configured to execute a vector divide absolute accumulate instruction that, for corresponding elements of the first data and the second data, calculates the ratios of the second data elements to the first data elements, determines the differences between one and the ratios, determines the absolute values of the differences, and accumulates the absolute differences.

In a seventeenth aspect according to any one of the twelfth through sixteenth aspects, the processor is configured to determine the stabilized values by determining the stabilized values from a lookup table based on the normalized differences.

In an eighteenth aspect according to any one of the twelfth through seventeenth aspects, the processor is configured to determine the kernel output by determining an aggregated similarity metric by combining the stabilized values and determining the kernel output by applying a transformation to the aggregated similarity metric.

In a nineteenth aspect according to the eighteenth aspect, the processor is configured to determine the kernel output by computing an exponential based on the aggregated similarity metric.

In a twentieth aspect, a non-transitory computer-readable medium stores instructions which, when executed by a processor, cause the processor to perform operations including receiving first data and second data, determining normalized differences by calculating ratios of corresponding elements from the second data and the first data, determining stabilized values based on the normalized differences, determining a kernel output based on the stabilized values, and determining an output by performing a machine learning operation according to the kernel output.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving first data and second data;
determining normalized differences by calculating ratios of corresponding elements from the second data and the first data;
determining stabilized values based on the normalized differences;
determining a kernel output based on the stabilized values; and
determining an output by performing a machine learning operation according to the kernel output.

2. The method of claim 1, wherein determining the stabilized values comprises, for each normalized difference:
determining the stabilized value by squaring the difference between one and the normalized difference.

3. The method of claim 2, wherein determining the stabilized values comprises:
executing a vector divide square accumulate instruction that, for corresponding elements of the first data and the second data:
determines the ratios of the second data elements to the first data elements;
determines the differences between one and the ratios;
determines squared differences by squaring the differences; and
accumulates the squared differences.

4. The method of claim 1, wherein determining the stabilized values comprises, for each normalized difference:
determining the stabilized value by taking the absolute value of the difference between one and the normalized difference.

5. The method of claim 4, wherein determining the stabilized values comprises:
executing a vector divide absolute accumulate instruction that, for corresponding elements of the first data and the second data:
calculates the ratios of the second data elements to the first data elements;
determines the differences between one and the ratios;
determines the absolute values of the differences; and
accumulates the absolute differences.

6. The method of claim 1, wherein determining the stabilized values comprises:
determining the stabilized values from a lookup table based on the normalized differences.

7. The method of claim 1, wherein determining the kernel output comprises:
determining an aggregated similarity metric by combining the stabilized values; and
determining the kernel output by applying a transformation to the aggregated similarity metric.

8. The method of claim 7, wherein determining the aggregated similarity metric by combining the stabilized values comprises:
determining the aggregated similarity metric by summing the stabilized values.

9. The method of claim 7, wherein the transformation comprises:
determining the kernel output by computing an exponential based on the aggregated similarity metric.

10. The method of claim 9, wherein computing the exponential based on the aggregated similarity metric comprises:
determining the kernel output from a lookup table based on the aggregated similarity metric.

11. The method of claim 1, wherein determining the normalized differences comprises, for each corresponding element from the second data and the first data:
determining that the first data element is zero; and
adding a predetermined value to the first data element.

12. A processor configured to:
receive first data and second data;
determine normalized differences by calculating ratios of corresponding elements from the second data and the first data;
determine stabilized values based on the normalized differences;
determine a kernel output based on the stabilized values; and
determine an output by performing a machine learning operation according to the kernel output.

13. The system of claim 12, wherein the processor is configured to determine the stabilized values by, for each normalized difference:
determining the stabilized value by squaring the difference between one and the normalized difference.

14. The system of claim 13, wherein the processor is configured to:
execute a vector divide square accumulate instruction that, for corresponding elements of the first data and the second data:
determines the ratios of the second data elements to the first data elements;
determines the differences between one and the ratios;
determines squared differences by squaring the differences; and
accumulates the squared differences.

15. The system of claim 12, wherein the processor is configured to determine the stabilized values by, for each normalized difference:
determining the stabilized value by taking the absolute value of the difference between one and the normalized difference.

16. The system of claim 15, wherein the processor is configured to:
execute a vector divide absolute accumulate instruction that, for corresponding elements of the first data and the second data:
calculates the ratios of the second data elements to the first data elements;
determines the differences between one and the ratios;
determines the absolute values of the differences; and
accumulates the absolute differences.

17. The system of claim 12, wherein the processor is configured to determine the stabilized values by:
determining the stabilized values from a lookup table based on the normalized differences.

18. The system of claim 12, wherein the processor is configured to determine the kernel output by:
determining an aggregated similarity metric by combining the stabilized values; and
determining the kernel output by applying a transformation to the aggregated similarity metric.

19. The system of claim 18, wherein the processor is configured to determine the kernel output by computing an exponential based on the aggregated similarity metric.

20. A non-transitory, computer-readable medium storing instructions which, when executed by a processor, cause the processor to perform operations, comprising:
receiving first data and second data;
determining normalized differences by calculating ratios of corresponding elements from the second data and the first data;
determining stabilized values based on the normalized differences;
determining a kernel output based on the stabilized values; and
determining an output by performing a machine learning operation according to the kernel output.
